(19) United States
(12) Patent Application Publication
(10) Pub. No.: US 2015/0134311 A1
(43) Pub. Date: May 14, 2015

(54) Modeling Effectiveness of Verum

(71) Applicants: Ralph Grothmann, Munchen (DE); Christoph Tietz, Ottobrunn (DE); Hans-Georg Zimmermann, Starnberg/Percha (DE)

(72) Inventors: Ralph Grothmann, Munchen (DE); Christoph Tietz, Ottobrunn (DE); Hans-Georg Zimmermann, Starnberg/Percha (DE)

(21) Appl. No.: 14/075,946

(22) Filed: Nov. 8, 2013

(51) Int. Cl. G06F 19/00

(52) U.S. Cl. CPC G06F 19/3437
USPC 703/6

(57) ABSTRACT

Modeling effectiveness of a verum includes dividing a group of patients into a placebo group and a verum group, defining a plurality of characteristics of the group of patients, and generating a model for the placebo group based on the plurality of characteristics. The method also includes generating a model for the verum group based on the plurality of characteristics, and isolating a placebo effect in the verum group in order to determine a pure verum effect.

### BACKGROUND

The present embodiments are directed towards modeling the effectiveness of a verum.

The challenge with a clinical trial is to analyze and investigate the verum and placebo effects for treating a disease syndrome in two groups of patients. The two groups are a placebo group and a verum group. The effectiveness of the verum (e.g., the active drug that is analyzed) may be inferred from the average dissimilarity in the evaluation of the two groups. This problem is currently examined and analyzed by statistical methods.

### SUMMARY AND DESCRIPTION

The scope of the present invention is defined solely by the appended claims and is not affected to any degree by the statements within this summary.

The above described approach of analyzing and investigating the verum and placebo effects for treating a disease syndrome is questionable. The actual question is how each single person reacts to the taking of the verum or the placebo. Also, the taking of the verum involves a placebo effect. Thus, the question is to be answered what the added value of the verum is compared to the placebo. The present embodiments may obviate one or more of the drawbacks or limitations in the related art. For example, the shortcomings of the state of the art may be overcome.

According to an aspect, in order to model the effectiveness of a verum, a group of patients is divided into a placebo group and a verum group. A plurality of characteristics of the group of patients is defined. A model for the placebo group is generated on the basis of the plurality of characteristics. A model for the verum group is generated based on the plurality of characteristics. In order to determine a pure verum effect, a placebo effect in the verum group is isolated.

According to another aspect, a system for modeling the effectiveness of a verum is proposed. The system includes means for dividing a group of patients into a placebo group and a verum group, means for defining a plurality of characteristics of the group of patients, and means for generating a model for the placebo group based on the plurality of characteristics. The system also includes means for generating a model for the verum group based on the plurality of characteristics, and means for isolating a placebo effect in the verum group in order to determine a pure verum effect.

According to another aspect, a non-transitory computer-readable storage medium with an executable program code stored thereon is proposed. The program code instructs a processor to divide a group of patients into a placebo group and a verum group. The program code also instructs the processor to define a plurality of characteristics of the group of patients, to generate a model for the placebo group based on the plurality of characteristics, and to generate a model for the verum group based on the plurality of characteristics. The program code instructs the processor to isolate a placebo effect in the verum group in order to determine a pure verum effect.

### BRIEF DESCRIPTION OF THE DRAWINGS

FIG. 1 is a block diagram of one embodiment of a system for modeling effectiveness of a verum;

FIG. 2A is a flow diagram of one embodiment of a method for modeling effectiveness of a verum;

FIG. 2B is a flow diagram of one embodiment of a method for modeling effectiveness of a verum; and

FIG. 3 is a block diagram of one embodiment of the system of FIG. 1 showing a non-transitory computer-readable storage medium with an executable program code stored thereon.

### DETAILED DESCRIPTION

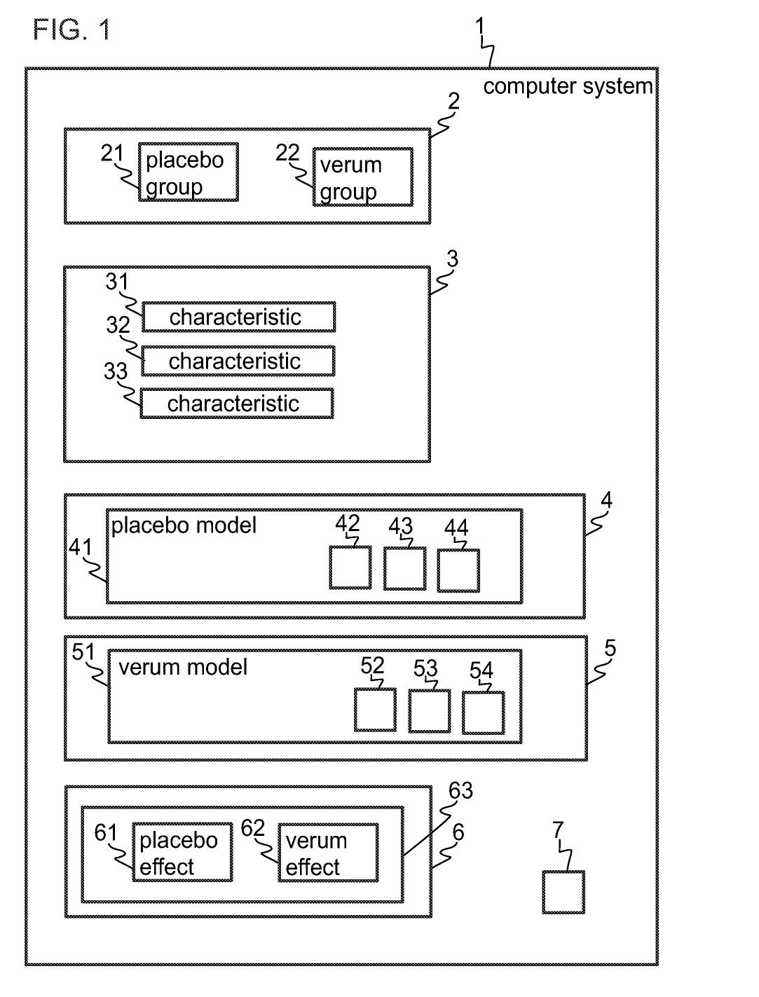

FIG. 1 is a block diagram of one embodiment of a computer system 1 for modeling effectiveness of a verum. The computer system 1 may, for example, be a computer or a group of computers (e.g., including one or more processors) connected together to a computer system. The system 1 includes a device or unit 2 for dividing a group of patients into a placebo group 21 and a verum group 22, a device or unit 3 for defining a plurality of characteristics 31, 32, 33 of the group of patients, and a device or unit 4 for generating a model 41 for the placebo group 21 based on the plurality of characteristics 31. The system 1 also includes a device or unit 5 for generating a model 51 for the verum group 22 based on the plurality of characteristics 31, 32, 33, a device or unit 6 for isolating a placebo effect 61 in the verum group in order to determine a pure verum effect 62, and a device or unit 7 for determining which values of the plurality of characteristics 31, 32, 33 result in a high effectiveness of the verum. In one embodiment, a processor may include the units 2, 3, 4, 5, 6, and 7. In one embodiment, one or more of the units 2, 3, 4, 5, 6, 7 may be separate processors.

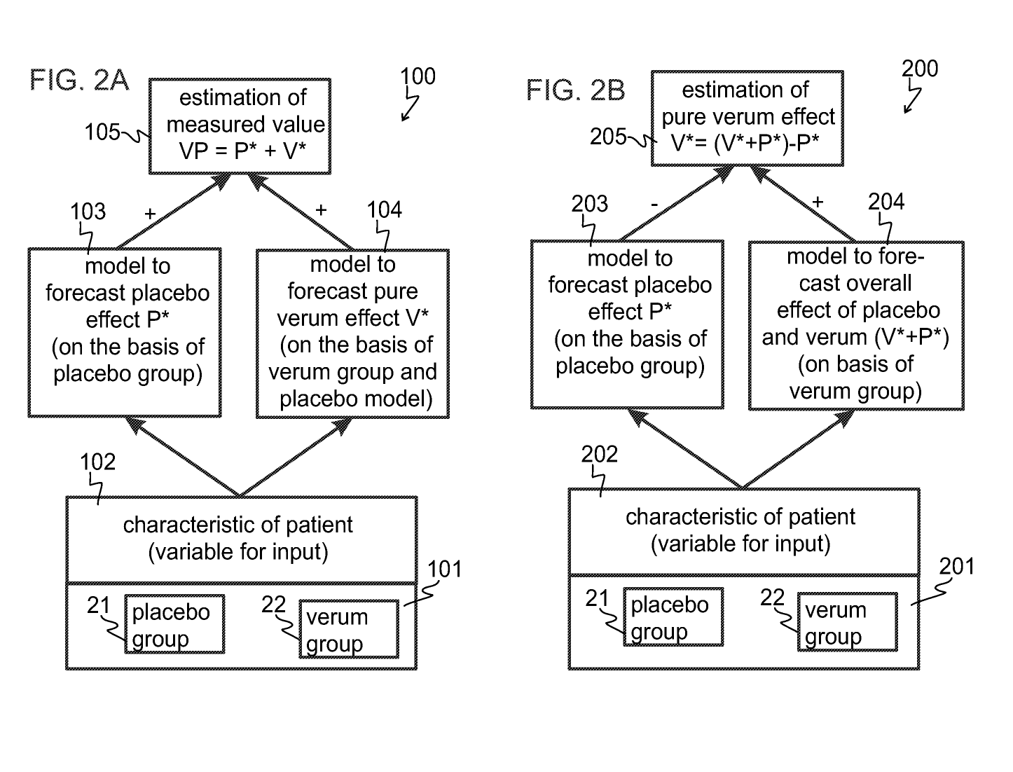

FIGS. 2A and 2B illustrate two alternative embodiments of methods for determining the pure verum effect based on the plurality of characteristics of the patients.

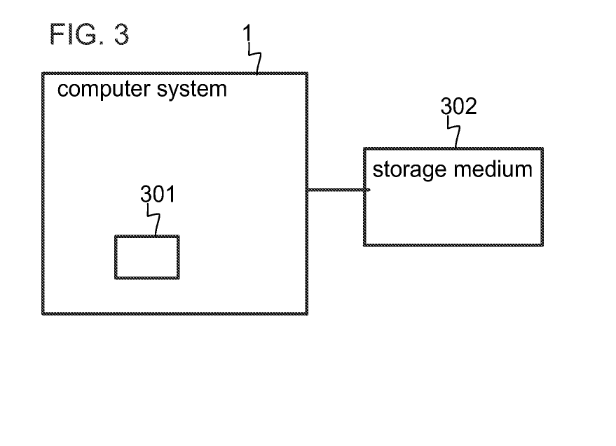

FIG. 3 is a block diagram of one embodiment of the system 1 of FIG. 1, together with a non-transitory computer-readable storage medium with an executable program code stored thereon. The program code instructs a processor of the computer system to perform an embodiment of the methods (e.g., the methods as described in more detail on the basis of FIG. 2A or FIG. 2B).

In one embodiment that is further described and illustrated by FIG. 2B, the model 51 for the verum group 22 is adapted to provide a forecast for the combination 63 of the placebo effect and the verum effect. The pure verum effect 62 is determined by isolating a placebo effect by subtracting the placebo effect 61 from the combination 63 of the placebo effect and the verum effect.

According to another embodiment that is further described and illustrated by FIG. 2A, the model 41 for the placebo group 21 is applied to the verum group 22 in order to estimate the pure verum effect 62 as a difference between an actual observation of the effectiveness of the verum and a forecast of the model for the placebo group. A model for the pure verum effect is generated based on the difference.

According to one embodiment, the device or unit 4 for generating the model 41 for the placebo group 21 is adapted to generate the model 41 for the placebo group 21 using a neural network 42.

According to another embodiment, the device or unit 5 for generating the model 51 for the verum group 22 is adapted to generate the model 51 for the verum group 22 using a neural network 52.

According to one embodiment, a model for the pure verum effect is generated by isolating a placebo effect in the verum group in order to determine a pure verum effect 53. The pure verum effect 62 is forecasted for a patient by applying the model for the pure verum effect on the plurality of characteristics of the patient.

According to one embodiment, each of the models 51 of the verum group and the models 41 for the placebo group are deployed by an ensemble of neural networks 42, 43, 44, 52, 53, 54. The neural networks 42, 43, 44 shown in Figure, 1 for example, include the ensemble for the placebo model 41, while the neural networks 52, 53, 54 include the ensemble for the verum model 51. The neural networks in each of the ensembles are independent of each other and combined together.

FIG. 2A is a flow diagram of one embodiment of a method 100 for modeling effectiveness of a verum. The method includes act 101 of dividing a group of patients into a placebo group 21 and a verum group 22. In act 102, a plurality of characteristics 31, 32, 33 of the patients is defined as input variables. Characteristics 31, 32, 33 of the patient may, for example, be selected from the group of gender, age, size, weight, body mass index, concomitant medication, sleep disturbance, and months since pain diagnosed. In act 103, a model for forecasting a placebo effect P* based on the placebo group 21 is generated based on the characteristics 31, 32, 33. In act 104, a model for forecasting the pure verum effect V* based on the verum group 22 and the placebo model 41 based on the characteristics is generated. In act 105, the placebo effect 61 is isolated in the verum group by estimating a measured value 63 of a patient on the basis of the equation:

VP=P*+V*,

where VP is the measured value, P* is the placebo effect, and V* is the pure verum effect 62.

According to embodiments, the problem of analyzing and investigating the verum and placebo effects 61, 62 for treating a disease syndrome is approached by a mathematical analysis and not by an experiment. A model 41 is generated by the data of the placebo group 21. The model 41 calculates the effect of the placebo for any patient. When this model 41 is applied to the patients of the verum group 22, the placebo effect in the verum group 22 may be isolated from the measured pain relief. This difference represents a consistent examination of the impact of the verum to the pain relief. For very large groups of patients, the so found conclusion is expected to converge to the mean value for patients since the individual characteristic of the patients increasingly cancel each other out.

On the basis of neural networks, a method for determining characteristics of persons who have an as large as possible difference between verum effect 61 and placebo effect 62, 63 is provided. The neural networks 42, 43, 44, 52, 53, 54 may involve a high-dimensional and nonlinear modeling. The models may be used for simulating a behavior of a patient.

According to one embodiment, neural networks and/or a particular neural network architecture are applied. Neural networks are able to recognize linear and nonlinear connections between one or more target variables and a large number of independent variables. This capability of nonlinear approximation in combination with robust scalability in the context of high-dimensional data makes neural networks a good tool for analysis in comparison to classical mathematical-statistical methods, most of which are limited to depicting linear relationships. In one or more of the present embodiments, the target variables indicate the effectiveness of the verum, while the characteristics of the patients are represented by the independent variables.

One or more of the present embodiments for modeling target variables in the verum group 22 and the placebo group 21 reflect the fact or the assumption that each kind of treatment involves a placebo effect 61 that influences the target variable. In order to separate this placebo effect 61 from the pure effect of the verum, at least one neural network 42, 43, 44 may be set up exclusively for the patients of the placebo group 21. The at least one neural network 42, 43, 44 may learn at that time the connection between the target variable and the characteristics of the patients of the placebo group 21. In other words, the at least one neural network 42, 43, 44 learns to forecast the response of the patient to the placebo based on the characteristics of the patient from the placebo group 21. In the model 41, the response of the patient is expressed as the target variable when administering the placebo.

According to one embodiment, the at least one neural network 42, 43, 44 that is trained exclusively with the data of the placebo group 21 is then applied to all patients of the verum group 22. Given the characteristics of a patient of the verum group, the at least one neural network 42, 43, 44 will then thus provide a forecast of the placebo effect 61 for that patient, and the at least one neural network 42, 43, 44 will thus provide the behavior of that patient when administering the placebo to him. The forecasted value for the placebo effect 61 may be compared with the measured patient's value that is composed of the verum effect and the placebo effect. For example, in a simulation, the difference between the measured value of the target variable from the verum group 22 and the forecasted placebo value provides valuable findings for the selection of the patients. Patients showing a large difference between the two values respond very well to the verum and very restrained to the placebo, and the values of the characteristics of these patients therefore result in a high effectiveness of the verum.

With the placebo-corrected data of the verum group 22, a model describing the pure verum effect 62 for any patient may, in the following, be generated, as described on the basis FIG. 2A.

Alternatively, with reference to FIG. 2B, the pure effect 62 of the verum may also be determined by generating a model 51a exclusively with the data of the patients of the verum group 21, where the model 51 consequently provides a forecast of a patient's overall reaction 63 to the verum including his individual placebo effect 61. The isolated placebo effect may be subtracted from the forecast including the verum effect and the placebo effect in order to obtain the pure verum effect, as described in FIG. 2B.

FIG. 2B is a flow diagram of one embodiment of a method 200 for modeling the effectiveness of a verum. Equivalent to FIG. 1, the method 200 includes act 201 of dividing a group of patients into a placebo group 21 and a verum group 22, and an act 202 of defining a plurality of characteristics 31, 32, 33 of the patients as input variables. The method 200 also includes an act 203 of generating a model for forecasting a placebo effect P* based on the placebo group 21 and on the characteristics 31, 32, 33. In contrast to the method 100, the method 200 includes act 204 in which a model for forecasting the overall effect of placebo and verum (V*+P*) based on the verum group is generated. In act 205, the placebo effect 61 is isolated in the verum group by estimating the pure verum effect 62 of a patient on the basis of the equation:

V*=(V*+P*)−P*.

According to one or more of the present embodiments, for the simulation (e.g., the estimation of the response of a new patient or a patient with amended characteristics to the placebo and verum) and the estimation of the relevance of individual independent variables (e.g., characteristics of the patients) during the forecast of the target variable, the two models may be combined. The two models are connected to each other in an integrated model structure such that the isolated effect of the verum may be metered directly.

According to one or more of the present embodiments, estimation of the relevance of the input (e.g., the identification of particularly relevant characteristics of patients) is done by the integrated model. The sensitivity of the isolated verum 62 effect is measured as a reaction of changes of the characteristics of the patients. Hence, characteristics of the patients resulting in an as high as possible (calculated) value for the effectiveness of the verum may be provided.

According to one or more of the present embodiments, the modeling of the effectiveness of the verum is used for optimizing a clinical study.

Methodically, according to one or more of the present embodiments, each of the model for the verum group and the model for the placebo group may be provided by an ensemble of neural networks. In an ensemble, a group of neural networks that are independent of each other are combined together. Every single neural network learns the connection between the target variable and the independent variables. The variation in the single forecasts for the target variable results from the random initialization of the model parameters and stochastic optimization of the model parameters for the mapping of the data structures, as well as from the selection of (random) subsets from the independent variables for explanation of the target variable. Additionally, the structure of the individual neural networks may be varied with regard to the number and size of information processing network layers in order to obtain diverse forecasts for the target variable. In the result, it may be shown that a combination of different forecasting models in the form of a simple mean value of the single forecasts increases the quality of the forecast. In addition, it is recommendable not to assess the relevance of the independent variables based on a single model, but based on the analysis of different independent models. Another advantage of combining neural networks in an ensemble is that the dissimilarity of the individual models within the ensemble may be understood as a measure of the uncertainty of the ensemble forecast. When the model outputs show a very low difference in the forecast of the target variable, the uncertainty of the forecast based on the presented data and the identified data structures is low. When the model outputs show a very high difference in the forecast of the target variable, the uncertainty of the forecast based on the presented data and the identified data structures is high. Consequently, for example, within a simulation, not only an expected value for the target variable is provided for a patient but also the uncertainty of the expected value. Aforementioned uncertainty may be used as a confidence interval. Accordingly, in the integrated model, the isolated verum effect is calculated based on the ensemble forecast. A confidence interval may be provided based on the ensemble as well.

It is to be understood that the elements and features recited in the appended claims may be combined in different ways to produce new claims that likewise fall within the scope of the present invention. Thus, whereas the dependent claims appended below depend from only a single independent or dependent claim, it is to be understood that these dependent claims can, alternatively, be made to depend in the alternative from any preceding or following claim, whether independent or dependent, and that such new combinations are to be understood as forming a part of the present specification.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. A method for modeling effectiveness of a verum, the method comprising:
dividing a group of patients into a placebo group and a verum group;
defining a plurality of characteristics of the group of patients;
generating a model for the placebo group based on the plurality of characteristics;
generating a model for the verum group based on the plurality of characteristics; and
isolating a placebo effect in the verum group in order to determine a verum effect.

2. The method of claim 1, wherein the model for the verum group provides a forecast for a combination of the placebo effect and the verum effect, and
wherein the method further comprises determining the verum effect, the determining comprising subtracting the placebo effect from the combination of the placebo effect and the verum effect.

3. The method of claim 1, further comprising:
applying the model for the placebo group to the verum group in order to estimate the verum effect as a difference between an actual observation of the effectiveness of the verum and a forecast of the model for the placebo group; and
generating a model for the verum effect based on the difference.

4. The method of claim 1, wherein generating the model for the placebo group comprises generating the model for the placebo group using a neural network.

5. The method of claim 1, wherein generating the model for the verum group comprises generating the model for the verum group using a neural network.

6. The method of claim 1, further comprising:
generating a model for the verum effect, the generating of the model for the verum effect comprising isolating a placebo effect in the verum group in order to determine the verum effect; and
forecasting the verum effect for a patient, the forecasting comprising applying the model for the verum effect on the characteristics of the patient.

7. The method of claim 1, further comprising determining which values of the characteristics result in a higher effectiveness of the verum.

8. The method of claim 1, wherein the model for the verum group and the model for the placebo group are deployed using an ensemble of neural networks.

9. The method of claim 8, wherein the neural networks in each of the ensembles are independent of each other and combined together.

10. The method of claim 1, wherein the method is implemented on a computer system.

11. A system for modeling effectiveness of a verum, the system comprising:
means for dividing a group of patients into a placebo group and a verum group;
means for defining a plurality of characteristics of the group of patients;
means for generating a model for the placebo group based on the plurality of characteristics;
means for generating a model for the verum group based on the plurality of characteristics;
means for isolating a placebo effect in the verum group in order to determine a pure verum effect.

12. The system of claim 11, wherein the model for the verum group provides a forecast for a combination of the placebo effect and a verum effect, and
wherein the pure verum effect is determinable by the means for isolating a placebo effect by subtracting the placebo effect from the combination of the placebo effect and the verum effect.

13. The system of claim 11, wherein the model for the placebo group is appliable to the verum group in order to estimate the pure verum effect as a difference between an actual observation of the effectiveness of the verum and a forecast of the model for the placebo group, and
wherein a model for the pure verum effect is generatable based on the difference.

14. The system of claim 11, wherein the means for generating the model for the placebo group is adapted to generate the model for the placebo group using a neural network.

15. The system of claim 11, wherein the means for generating the model for the verum group is adapted to generate the model for the verum group using a neural network.

16. The system of claim 11, wherein a model for the pure verum effect is generatable by isolating the placebo effect in the verum group in order to determine the pure verum effect, and
wherein the pure verum effect is forecastable for a patient by applying the model for the pure verum effect on the plurality of characteristics of the patient.

17. The system of claim 11, further comprising means for determining which values of the plurality of characteristics result in a higher effectiveness of the verum.

18. The system of claim 11, wherein the model for the verum group and the model for the placebo group are deployable using an ensemble of neural networks.

19. The system of claim 18, wherein the neural networks in each of the ensembles are independent of each other and combined together.

20. The system of claim 11, wherein the system is a computer system.

21. A non-transitory computer-readable storage medium storing program code having instructions executable by a processor, the instructions comprising:
dividing a group of patients into a placebo group and a verum group;
defining a plurality of characteristics of the group of patients;
generating a model for the placebo group based on the plurality of characteristics;
generating a model for the verum group based on the plurality of characteristics;
isolating a placebo effect in the verum group in order to determine a pure verum effect.

22. The non-transitory computer-readable storage medium of claim 21, wherein the instructions further comprise:
providing, with the model for the verum group, a forecast for a combination of the placebo effect and a verum effect; and
determining the pure verum effect, the determining comprising subtracting the placebo effect from the combination of the placebo effect and the verum effect.

23. The non-transitory computer-readable storage medium of claim 21, wherein the instructions further comprise:
applying the model for the placebo group to the verum group in order to estimate the pure verum effect as a difference between an actual observation of the effectiveness of the verum and a forecast of the model for the placebo group; and
generating a model for the pure verum effect based on the difference.

24. The non-transitory computer-readable storage medium of claim 21, wherein generating the model for the placebo group comprises generating the model for the placebo group using a neural network.

25. The non-transitory computer-readable storage medium of claim 21, wherein generating the model for the verum group comprises generating the model for the verum group using a neural network.

26. The non-transitory computer-readable storage medium of claim 21, further comprising:
generating a model for the pure verum effect, the generating of the model for the pure verum effect comprising the isolating of the placebo effect in the verum group in order to determine the pure verum effect; and
forecasting the pure verum effect for a patient, the forecasting comprising applying the model for the pure verum effect on the plurality of characteristics of the patient.

27. The non-transitory computer-readable storage medium of claim 21, wherein the instructions further comprise determining which values of the plurality of characteristics result in a higher effectiveness of the verum.

28. The non-transitory computer-readable storage medium of claim 21, wherein the model of the verum group and the model for the placebo group are deployed using an ensemble of neural networks.

29. The non-transitory computer-readable storage medium of claim 28, wherein the neural networks in each of the ensembles are independent of each other and combined together.

30. The non-transitory computer-readable storage medium of claim 21, wherein the processor is comprised by a computer system.
